(19) United States
(12) Patent Application Publication
(10) Pub. No.: US 2025/0129651 A1
(43) Pub. Date: Apr. 24, 2025

(54) WINDOW SYSTEM, HINGE MECHANISM FOR A WINDOW SYSTEM, AND CORNER JOINT FOR A WINDOW SYSTEM

(71) Applicant: Visionar Window Systems Inc., Langley (CA)

(72) Inventor: Johan Sawatzky, Chilliwack (CA)

(21) Appl. No.: 18/383,471

(22) Filed: Oct. 24, 2023

(51) Int. Cl. E05F 11/34

(52) U.S. Cl. CPC E05F 11/34; E05Y 2201/696; E05Y 2900/148

(57) ABSTRACT

A window system includes a window movable relative to a window frame, and a device for opening and closing the window. The device includes a lead screw and at least one rigid arm connecting the window to the lead screw. Operation of the device for opening and closing the window causes the at least one rigid arm to move between a first position in which the window is closed and a second position in which the window is open.

### FIELD OF THE INVENTION

The present disclosure relates to devices and systems for windows, and in particular to a window system, a hinge mechanism for a window system, and a corner joint for a window system.

### BACKGROUND OF THE INVENTION

Traditional devices for opening and closing windows, especially side-hung windows, generally include a manually-operated handle connected to a series of mechanical gears. Drawbacks of such devices include the fact that it can be difficult to allow both opening/unlocking and closing/locking of the window with the same hand motion. In addition, wear on the gears can cause premature failure of the opening/closing mechanism. And furthermore, existing hinges and opening/closing mechanisms for windows tend to struggle with the weight of oversize windows.

### SUMMARY OF THE INVENTION

According to a first aspect of the disclosure, there is provided a window system comprising: a window movable relative to a window frame; and a device for opening and closing the window, comprising: a lead screw; and at least one rigid arm connecting the window to the lead screw, wherein operation of the device for opening and closing the window causes the at least one rigid arm to move between a first position in which the window is closed and a second position in which the window is open.

The device for opening and closing the window may comprise an actuator. The lead screw may comprises at least one threaded shaft and at least one threaded nut engaged to the at least one threaded shaft. Operation of the actuator may cause the at least one threaded shaft to rotate and thereby cause corresponding translation of the at least one threaded nut between an extended position and a retracted position for respectively moving the at least one rigid arm between the first position and the second position.

The at least one threaded nut may be connected to the at least one rigid arm.

The actuator may comprise a handle for manually operating the device for opening and closing the window.

The at least one threaded nut may comprise a first threaded nut connected to the at least one rigid arm, and a second threaded nut connected to the handle. Translation of the handle may cause corresponding translation of the second threaded nut and corresponding rotation of the at least one threaded shaft.

The handle may be configured to be operated in response to a load of at least 5 pounds being applied to the handle.

The actuator may comprise a motor operable to drive rotation of the at least one threaded shaft.

The at least one threaded shaft may comprise thereon: a thread of a first pitch; and a thread of a second pitch steeper than the first pitch.

The at least one threaded nut may comprise: a first threaded nut connected to the at least one rigid arm and engaged to the thread of the second pitch; and a second threaded nut connected to the actuator and engaged to the thread of the first pitch.

The window system may further comprise: a hinge connecting the window to a sill of the window frame; and a load-bearing suspension device connecting the window frame to the window.

One or both of the hinge and the load-bearing suspension device may comprise carbon fiber.

The load-bearing suspension device may comprise: a first end attached to the window frame; a second end attached to the window; and a flexible rod connecting the first and second ends and configured to rotate during opening or closing of the window relative to the window frame.

The hinge may be a three-part hinge consisting of: a bracket fixed to the sill; a first member pivotable relative to the bracket; a second member fixed to the window and pivotable relative to the first member; and a third member pivotable relative to the second member and the bracket.

The window system may further comprise a locking mechanism for locking the window when the window is closed. Operation of the device for opening and closing the window may further cause the locking mechanism to transition between a locked state in which the window is locked when the window is closed, and an unlocked state in which the window is unlocked.

Operation of the device for opening and closing the window may further cause the at least one rigid arm to move between the first position in which the window is closed and the locking mechanism is in the locked state, and the second position in which the window is open and the locking mechanism is in the unlocked state.

The locking mechanism may comprise: one or more first locking members on the window; and one or more second locking members coupled to the window frame and movable, in response to operation of the device for opening and closing the window, between a locked position in which the locking mechanism is in the locked state, and an unlocked position in which the locking mechanism is in the unlocked state.

The one or more second locking members may be movable relative to a vertical jamb of the window frame.

The one or more second locking members may be translatable between the locked position and the unlocked position.

The one or more second locking members may comprise one or more locking bars movably connected to the window frame and configured: when in the locked position and when the window is closed, to prevent movement of the one or more first locking members; and when in the unlocked position, to permit movement of the one or more first locking members.

The one or more locking bars may be rotatably connected to the window frame.

The one or more second locking members may be provided on a movable platform connected to a corner joint, and the lead screw may be connected to the corner joint.

The lead screw may comprise at least one threaded shaft engaged to at least one threaded nut connected to the corner joint. The corner joint may be configured to convert linear translation of the at least one threaded nut in a first direction into linear translation of the movable platform in a second direction.

The device for opening and closing the window may be provided on a sill of the window frame.

The window may be a side-hung window.

The at least one rigid arm may be articulated.

The at least one rigid arm may be connected to the window with a window operating control device for selectively controlling the extent to which the window may be opened relative to the window frame.

The window operating control device may comprise: a first portion rotatable relative to the at least one arm; and a second portion fixed to the window and adjustable between a first configuration in which the second portion is fixed relative to the first portion, and a second configuration in which the second portion is rotatable relative to the first portion.

The locking mechanism may be connected to the lead screw using an elongate flexible member passing through a corner joint, and rotation of the lead screw about its longitudinal axis may cause: a first portion of the elongate flexible member to move through the corner joint in a direction perpendicular to the longitudinal axis; and a second portion of the elongate flexible member to move through the corner joint in a direction parallel to the longitudinal axis.

The elongate flexible member may comprise a chain.

According to a further aspect of the disclosure, there is provided a hinge mechanism for a window pivotable relative to a window frame, wherein the hinge mechanism comprises: a hinge for connecting the window to a sill of the window frame; and a load-bearing suspension device comprising: a first end for attaching to the window frame; a second end for attaching to the window; and a flexible rod connecting the first and second ends and configured to rotate during opening or closing of the window relative to the window frame.

One or both of the hinge and the load-bearing suspension device may comprise carbon fiber.

The hinge may be a three-part hinge consisting of: a bracket for fixing to the sill; a first member pivotable relative to the bracket; a second member for fixing to the window and pivotable relative to the first member; and a third member pivotable relative to the second member and the bracket.

The window may be a side-hung or a top-hung window.

According to a further aspect of the disclosure, there is provided a corner joint for a window system, comprising: a first conduit extending in a first direction; a second conduit coupled to the first conduit and extending in a second direction perpendicular to the first direction; and a chain passing through the first and second conduits, wherein the first and second conduits define, where the first and second conduits meet, one or more portions for assisting a force extending along the chain in the first direction to be transmitted along the chain in the second direction.

The one or more portions may comprise one or more angled portions.

The one or more portions may comprise one or more curved portions.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 shows, in a closed state, a device for opening and closing a window, according to an embodiment of the disclosure;

FIG. 2 shows, in more detail, a lead screw of the device of FIG. 1, according to an embodiment of the disclosure;

FIG. 3 shows, in a locked state, a locking mechanism of the device of FIG. 1, according to an embodiment of the disclosure;

FIG. 4 shows, in more detail, the lead screw of FIG. 2 connected to the locking mechanism of FIG. 3 via a corner joint, according to an embodiment of the disclosure;

FIG. 5 shows the lead screw of FIG. 2 including a window operating control device, according to an embodiment of the disclosure;

FIG. 6 shows, in a closed state, a hinge for a window system, according to an embodiment of the disclosure;

FIG. 7 shows a window system including a closed window and the device of FIG. 1, according to an embodiment of the disclosure;

FIG. 8 shows, in an open state, the device of FIG. 1, according to an embodiment of the disclosure;

FIG. 9 shows, in more detail, the lead screw of the device of FIG. 8, according to an embodiment of the disclosure;

FIG. 10 shows, in an open state, the hinge of FIG. 6, according to an embodiment of the disclosure;

FIG. 11 shows, in more detail, a chain passing through the corner joint and interconnecting the lead screw of FIG. 9 to the locking mechanism of the device of FIG. 8, according to an embodiment of the disclosure;

FIG. 12 shows, in an unlocked state, the locking mechanism of the device of FIG. 8, according to an embodiment of the disclosure;

FIG. 13 shows a window system including an open window and the device of FIG. 8, according to an embodiment of the disclosure;

FIG. 14 shows a suspension rod according to an embodiment of the disclosure;

FIG. 15 shows the lead screw of FIG. 9 with the window operating control device in a modified position, according to an embodiment of the disclosure; and

FIG. 16 shows a cross-section of the corner joint, according to an embodiment of the disclosure.

### DETAILED DESCRIPTION OF THE PREFERRED EMBODIMENT

The present disclosure seeks to provide a novel window system, a novel hinge mechanism for a window system, and a novel corner joint for a window system. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a window system comprising a window movable relative to a window frame, and a device for opening and closing the window. The device includes a lead screw and at least one rigid arm connecting the window to the lead screw. Operation of the device causes the at least one rigid arm to move between a first position in which the window is closed (and in which the device is in a “closed state”), and a second position in which the window is open (and in which the device is in an “open state”). The lead screw may include a shaft having multiple threads of different pitches. Alternatively, the lead screw may include multiple, interconnected threaded shafts, with each threaded shaft having a thread of a particular pitch. This may increase the mechanical advantage provided by the lead screw, and may allow a user to relatively easily open and close the window by applying a relatively low amount of force to an actuator of the device. For example, according to some embodiments, as little as 5 pounds of force may be needed in order to operate the device for opening and closing the window. The lead screw may be configured to operate a wide range of windows, including oversize windows over 200 lbs.

According to some embodiments, operation of the device for opening and closing the window will cause a locking mechanism to engage/disengage, depending on whether the window is being opened or closed. For example, the locking mechanism may include a series of first locking members provided on a platform that is movably connected to the lead screw. The platform may be provided on a vertical jamb of the window frame. Operation of the device for opening and closing the window may therefore cause the platform to move which in turn may cause corresponding second locking members provided on a vertical sash of the window to disengage from the first locking members provided on the vertical jamb of the window frame. Therefore, in addition to being used to open and close the window, the lead screw may, in parallel, cause the window to be locked (when the window is in its closed position) or unlocked (prior to the window being opened).

Detailed embodiments of the disclosure will now be described in connection with the accompanying drawings.

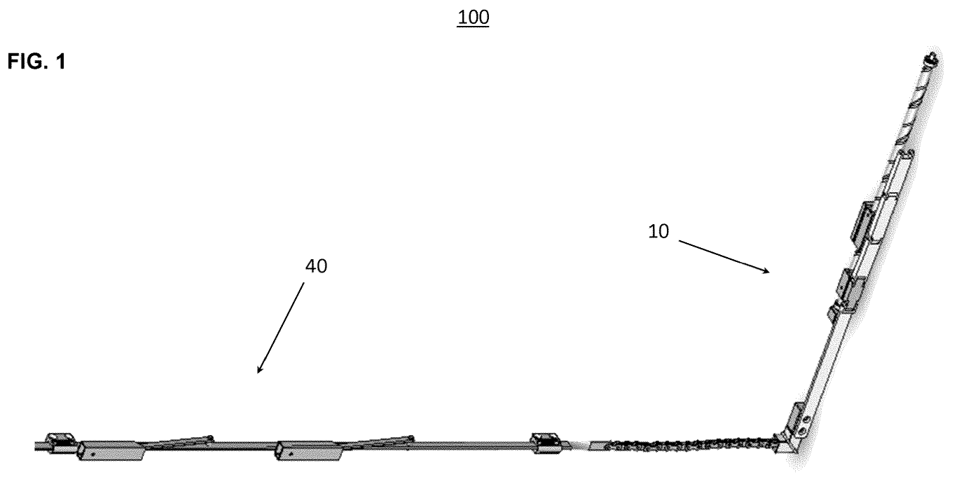

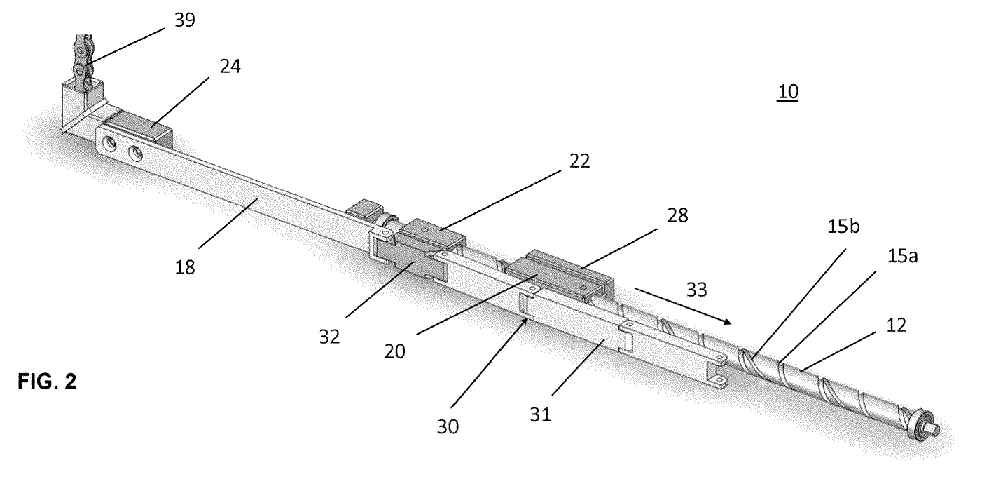

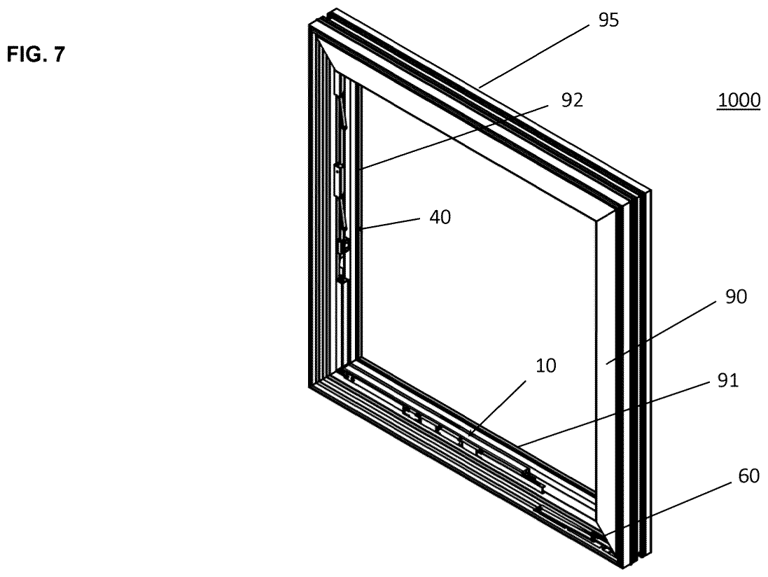

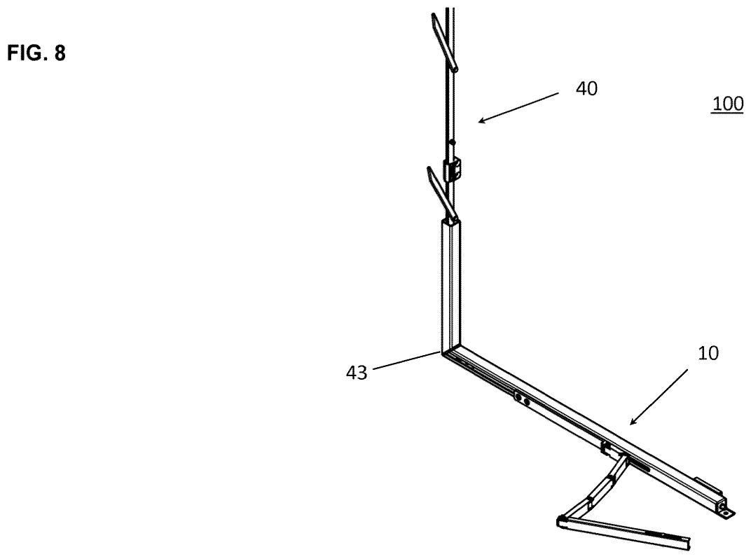

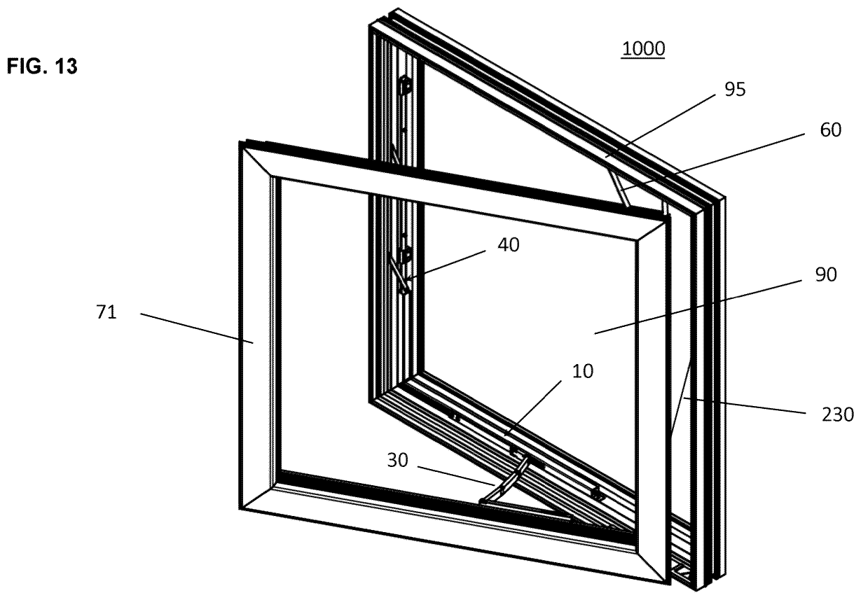

Turning to FIG. 1, there is shown a device 100 for opening and closing a window. In FIG. 1, device 100 is shown in a “closed” position; i.e., this is the position of device 100 when the window (not shown in FIG. 1) is closed. FIG. 1 is to be contrasted with FIG. 8 (described in further detail below) which shows device 100 in an “open” position; i.e., this is the position of device 100 when the window (not shown in FIG. 8) is open. For clarity purposes, components of the overall window system (including the window itself, and the window frame relative to which the window pivots) are omitted from FIG. 1 (as well as FIGS. 2-6 and 8-12), but are shown in FIGS. 7 and 13 in conjunction with device 100.

Device 100 includes a lead screw 10 and a locking mechanism 40. As will be made clear in later drawings, lead screw 10 may be secured to a window sill, and locking mechanism 40 may be secured to a window frame jamb. Operation of lead screw 10 leads to corresponding operation of locking mechanism 40 as described in further detail below.

FIG. 2 shows components of lead screw 10 in greater detail. In particular, lead screw 10 includes a threaded shaft 12 having thereon a thread of a first pitch 15a and a thread of a second pitch 15b. The pitch of thread 15b is steeper than the pitch of thread 15a. According to some embodiments, instead of having a single threaded shaft 12 with multiple threads of different pitches, lead screw may comprise multiple, interconnected threaded shaft portions, with each threaded shaft portion having its own thread of a particular pitch. For example, a first threaded shaft portion may have a thread of a first pitch, and a second threaded shaft portion may have a thread of a second, different pitch.

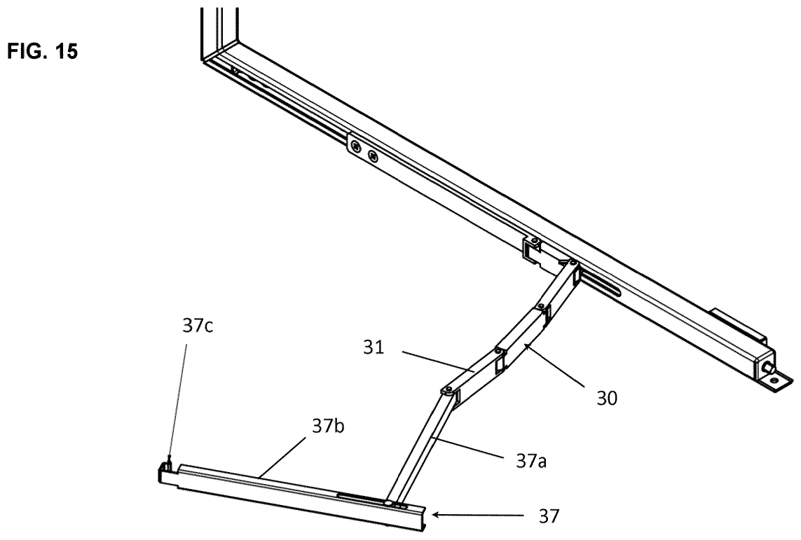

Lead screw 10 further includes a first threaded nut 20 engaged with thread 15b and which may translate along threaded shaft 12. Lead screw 10 further includes a second threaded nut 22 engaged with thread 15a and which may translate along threaded shaft 12. A rigid arm base 32 is fixed to threaded nut 22 and is connected to an articulating rigid arm 30. Rigid arm 30 includes a number of interconnected rigid arm portions 31 that may rotate relative to one another. Although not shown in FIG. 2, the end of the rigid arm portion 31 that is furthest from rigid arm base 32 is rotatably connected to a window operating control device 37 shown in more detail in FIG. 15 and described in further detail below. Window operating control device 37 is in turn fixed to a horizontal sash of the window. The articulation of rigid arm 30 may provide more opening force than if rigid arm 30 were formed of a single rigid arm portion 31. It shall be recognized that other types of rigid arms may be used to connect lead screw 10 to the window frame.

As also seen in FIG. 2, a manually-operable handle 28 is connected to threaded nut 20 (using, for example, a magnetic connection). Translation of handle 28 in the longitudinal direction defined by threaded shaft 12 (i.e., in the direction of arrow 33) results in translation of threaded nut 20 along threaded shaft 12, which in turn drives rotation of threaded shaft 12 through the engagement of threaded nut 20 with thread 15b of threaded shaft 12. Through the engagement of threaded nut 22 with thread 15a of threaded shaft 12, the rotation of threaded shaft 12 drives translation of threaded nut 22 in the direction of arrow 33. Translation of threaded nut 22 causes rigid arm 30 to pivot about rigid arm base 32 and drives the window to be opened, as will be made clear in later drawings.

In addition to being connected to one of rigid arm portions 31, rigid arm base 32 is further connected to one end of a connecting member 18. The other end of connecting member is connected to locking mechanism 40 by the intermediary of chain attachment guide 24 which it itself connected to a chain 39. Therefore, at the same that threaded shaft 12 is rotated, the corresponding translation of threaded nut 22 in the direction of arrow 33 results in corresponding translation of connecting member 18, and the activation of locking mechanism 40 (i.e. the transitioning of locking mechanism 40 from a locked state to an unlocked state), as described in further detail below.

Advantageously, because of the different pitches of the threads on threaded shaft 12, a mechanical advantage is provided to the user when operating handle 28, thereby allowing the user to operate lead screw 10 and open/close the window using a relatively low amount of force. For example, according to some embodiments, a user may operate lead screw 10 with as little as 5 pounds of force, and may open or close a window with a dimension of about 1 metre by about 1 metre. According to some embodiments, threaded shaft 12 may include one or more additional threads of different pitches, to further increase the mechanical advantage that is provided.

According to other embodiments, instead of using handle 28 connected to threaded nut 20, a motor may be used to drive rotation of threaded shaft 12. In such embodiments, there is no need for threaded nut 20.

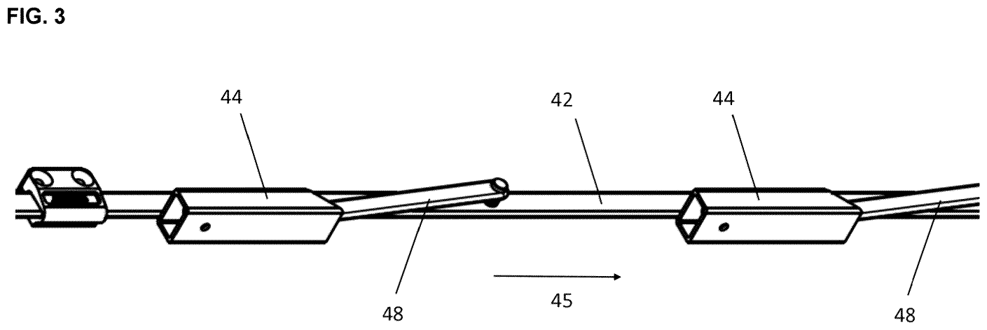

Turning now to FIG. 3, there is shown locking mechanism 40 in greater detail. Locking mechanism 40 includes a movable platform 42 on which is provided a series of pivotable, spring-loaded locking bars 48. First ends of pivotable locking bars 48 are rotatably connected to movable platform 42, and opposite second ends of locking bars 48 are secured within corresponding locking tubes 44 provided on a vertical sash of the window frame. Movable platform 42 is configured to be movable in response to translation of threaded nut 22, as described in further detail below. When platform 42 is moved downwardly in the direction of arrow 45, the second ends of locking bars 48 are removed from within locking tubes 44 and allow locking tubes 44 to move away from platform 42. As a result, the window may then swung into an open position. Platform 42 is configured to slide only up and down (i.e., vertically) relative to a vertical jamb of the window frame. In the configuration shown in FIG. 3, locking mechanism 40 is in the locked state. In the locked state, locking bars 48 prevent locking tubes 44, secured to the window, from being moved away from the window frame. As a result, in the locked state, the window is prevented from opening.

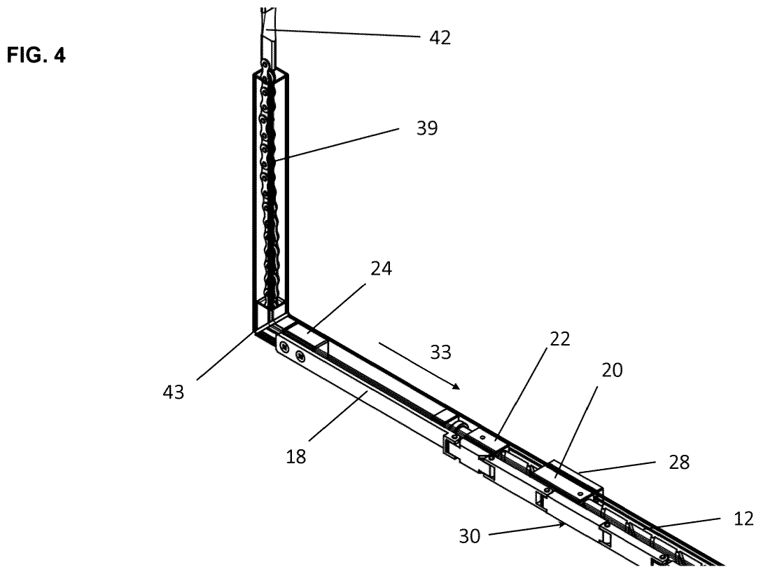

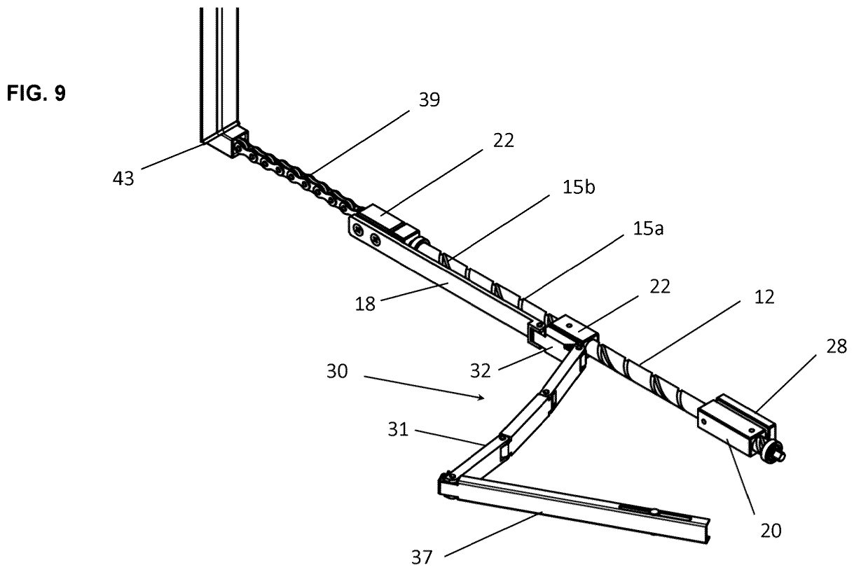

Turning now to FIG. 4, the interconnection between lead screw 10 and locking mechanism 40 is shown in more detail. In particular, movable platform 42 is connected to chain 39 which passes through a corner joint 43 and is in turn connected to chain attachment guide 24. As described above, through the operation of lead screw 10, and in particular in response to the translation of handle 28 in the direction of arrow 33, threaded nut 22 is caused to translate in the direction of arrow 33. During the operation of lead screw 10 from the closed position (FIG. 4) to the open position (FIGS. 8 and 9), threaded nut 22 is translated in the direction of arrow 33 and thereby causes connecting member 18 to also translate in the direction of arrow 33. This in turn cases chain attachment guide 24 to also translate in the direction of arrow 33, causing chain 39 to pull downwardly on movable platform 42. Platform 42 is therefore caused to translate downwardly and moves locking bars 48 out of their locking positions by causing locking bars 48 to be removed from locking tubes 44, as described above. At the end of operation of lead screw 10, lead screw 10 is in the open state shown in FIGS. 8 and 9 and described in further detail below.

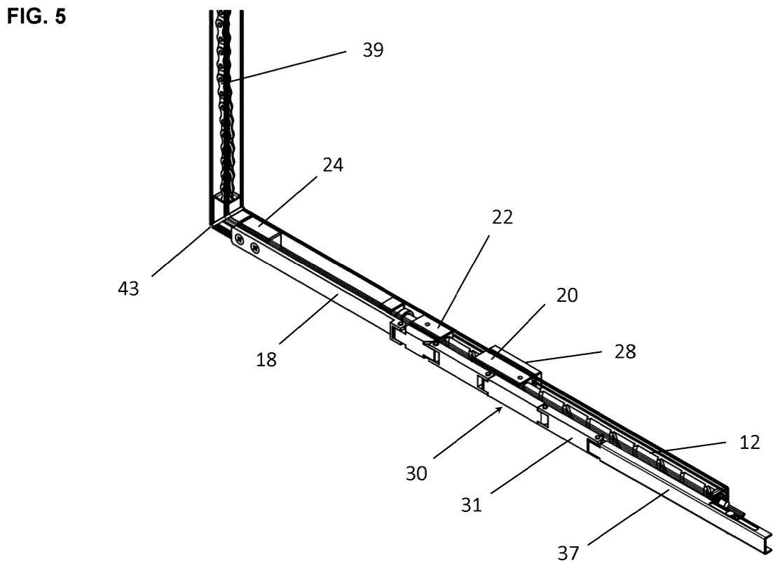

FIG. 5 shows another of threaded screw 10. In FIG. 5, as described above, the end of the rigid arm portion 31 that is furthest from rigid arm base 32 is shown rotatably connected to window operating control device 37, described in further detail below. In operation of device 100, window operating control device 37 is fixed to a horizontal sash of the window.

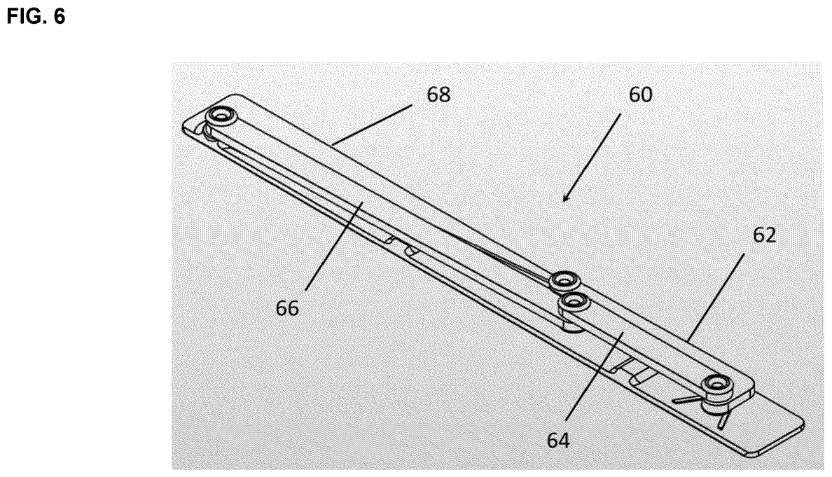

Turning now to FIG. 6, there is shown an additional component of device 100 that is not shown in FIG. 1. In particular, device 100 includes a three-part hinge 60 that is used to assist in the opening/closing of the window. Hinge 60 includes a bracket 68 that is connected to the sill of the window frame. Hinge 60 further includes a first hinge member 62 that is pivotally connected to bracket 68 and pivotally connected to a second hinge member 64. Second hinge member 64 is pivotally connected to a third hinge member 66 which is in turn pivotally connected to bracket 68. Although not shown in FIG. 6, second hinge member 64 is fixed to a horizontal sash of the window. Components of hinge 60 comprise a material with relatively good strength and flexibility, such as carbon fiber.

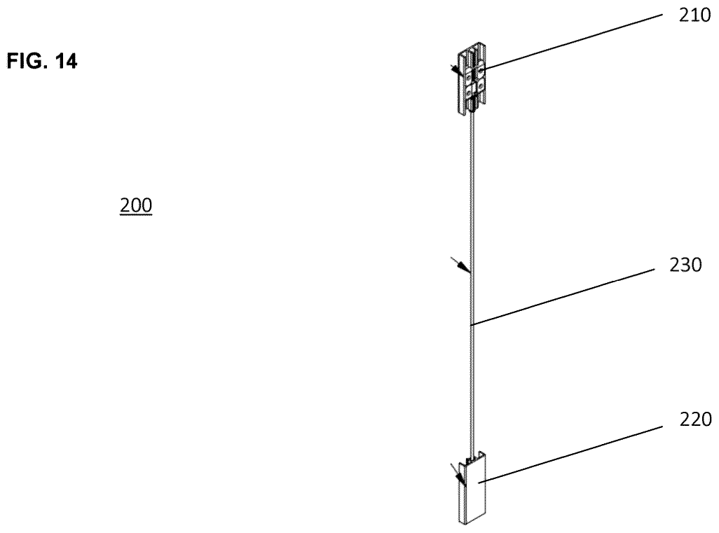

Hinge 60 is part of a hinge mechanism that additionally includes a suspension rod 200 shown in FIG. 14. Suspension rod 200 includes an upper end 210 and a lower end 220, and an elongate flexible torsion rod 230 extending between upper end 210 and lower end 220. Upper end 210 is secured to a vertical jamb of the window frame, and lower end 220 is secured to the sash of the window.

Unlike hinge 60, traditional window hinges are designed to support the full weight of the window, and because of this load-bearing requirement such hinges are designed to not flex. In contrast, according to the present embodiment, suspension rod 200 is designed to support the weight of the window while hinge 60 guides the opening and closing motion of the window. A material with relatively good strength and flexibility, such as carbon fiber, may be used for suspension rod 200 and hinge 60. Carbon fiber may allow hinge 60 to flex slightly in the vertical direction as the vertical distance between upper end 210 and lower end 220 decreases during opening of the window. Furthermore, torsion rod 230 is configured to rotate as the window opens, in order to prevent binding of hinge 60.

FIG. 7 shows a window system 1000 comprising device 100 and a window 90 pivotable relative to a window frame 95. Window 90 is in the closed position. As can be seen, lead screw 10 is provided on a sill 91 of window frame 95, while locking mechanism 40 extends in the vertical direction along a vertical jamb 92 of window frame 95. According to some embodiments, locking mechanism 40 may be provided along a different jamb of window frame 95, such as the upper horizontal jamb. According to such alternative embodiments, the corner joint interconnecting lead screw 10 and locking mechanism 40 will have to be modified.

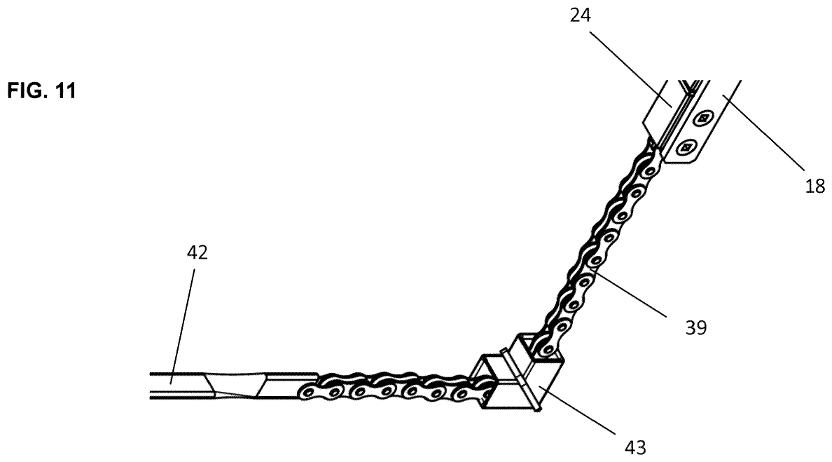

Turning to FIGS. 8 and 9, there is now shown device 100 in the opened position. This is the position arrived at as a result of translating threaded nut 20 (through the translation of handle 28) to the far end of threaded shaft 12 (i.e., to the end furthest from corner joint 43). As can be seen, as a result of the translation of threaded nut 22 away from corner joint 43, a portion of chain 39 has been pulled through corner joint 43 and has resulted in movable platform 42 being pulled downwardly (FIG. 11), thereby moving locking mechanism 40 from its locked state to its unlocked state. In FIG. 8, portions of lead screw 10 cannot be seen because of stainless steel tubing encasing portions of lead screw 10. As can also be seen in FIGS. 8 and 9, rigid arm 30 has pivoted about rigid arm base 32 and relative to threaded shaft 12, with the window (not shown) connected to window operating control device 37. The configuration of the window relative to lead screw 10, in the open state, is shown in more detail in FIG. 13.

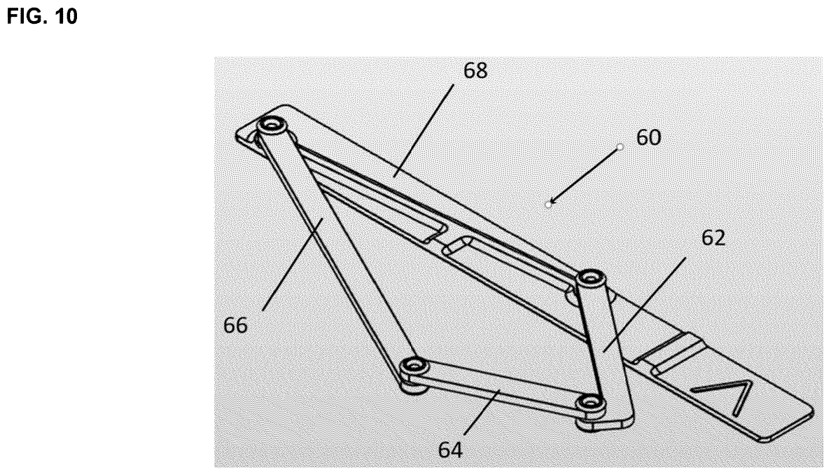

In FIG. 10, hinge 60 is shown in the open configuration, with hinge members 64, 66, 68 having pivoted to the configuration shown in the drawing in order to accommodate the opening of window 90.

FIG. 11 shows, in more detail, chain 39 interconnecting movable platform 42 and chain attachment guide 24 secured to connecting member 18.

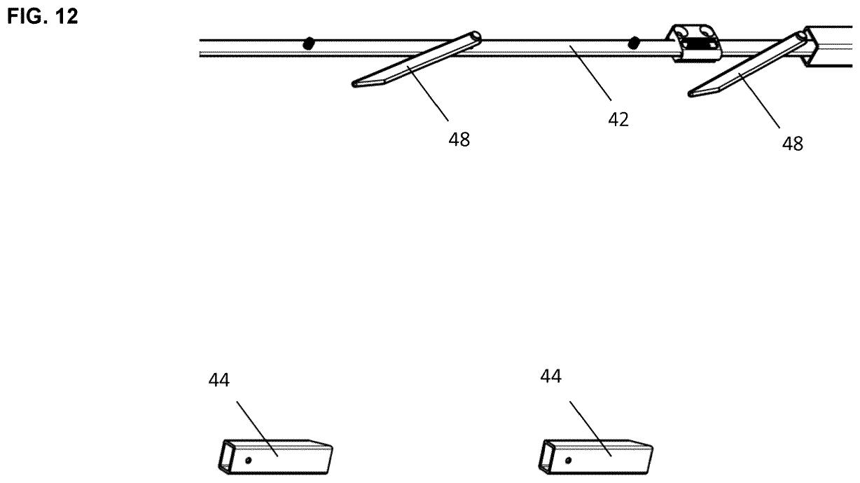

Turning now to FIG. 12, there is shown locking mechanism 40 in the unlocked state. In the unlocked state, the downward translation of movable platform 42 has resulted in locking bars 48 being removed from locking tubes 44. In particular, in response to the operation of lead screw 10 as described above, the opening of window 90 has resulted in corresponding actuation of locking mechanism 40 and unlocking of window 90 from window frame 95.

When window 90 is moved back to its closed position by reverse operation of lead screw 10, locking bars 48 are moved upwardly as a result of upward motion of movable platform 42, and the free ends of locking bars 48 are moved into locking tubes 44, thereby securing locking tubes 44 within locking bars 48 and securing window 90 in its locked position. In particular, once movement of handle 28 has reached its end point, locking tubes 44 will have been moved into positions so as to provide final closing pressure against locking bars 48, retaining the window in the locked position.

FIG. 13 shows window system 1000 with window 90 in an open position. As can be seen, rigid arm 30 has been pivoted outwardly to cause window 90 to transition to its open state. Although hinge 60 is not shown at the bottom of window 90 in FIG. 13, an identical three-piece hinge 60 is shown at the top of window 90. While upper end 210 and lower end 220 of suspension rod 200 are occluded from view, a portion of torsion rod 230 is visible.

As can be seen in FIG. 13, window 90 is shown in its maximally opened state. Window 90 may be opened further through operation of window operating control device 37. In particular, as can be seen in FIG. 15, window operating control device 37 includes a first portion 37a that is pivotable relative to a second portion 37b. In particular, a hook portion 37c of second portion 37b may be detached from first portion 37a, and may allow second portion 37b to be pivoted relative to first portion 37a, thereby increasing the degree to which window 90 may be opened relative to window frame 95. First portion 37a is pivotally connected to one of rigid arm portions 31, and second portion 37b is secured to window 90.

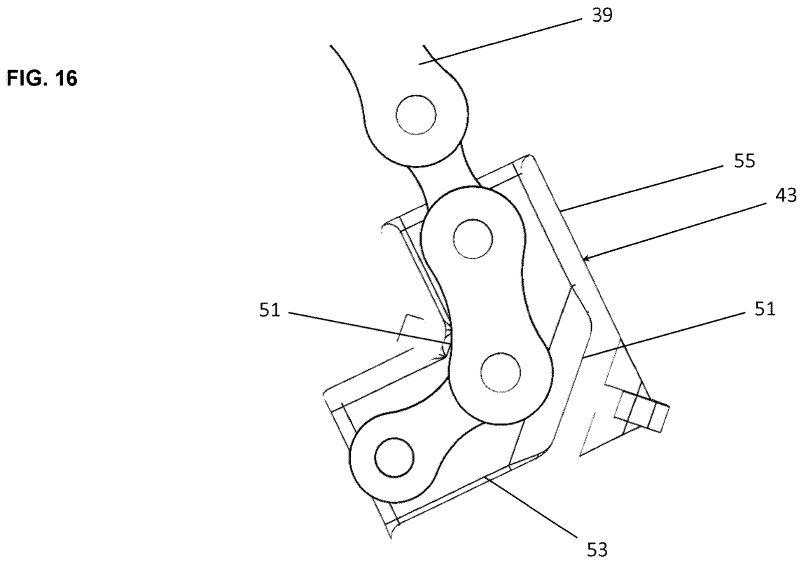

FIG. 16 shows a cross-section of corner joint 43 in more detail. As can be seen, corner joint 43 includes a first conduit 53 disposed at a right angle to a second conduit 55. Chain 39 passes through an open end of first conduit 53 and exits corner joint 43 via an open end of second conduit 55. First conduit 53 and second conduit 55 define angled sides 51 that are angled relative to the general directions of extension of first and second conduits 53 and 55. For example, angled sides 51 may be angled at 45 degrees relative to the general directions of extension of first and second conduits 53 and 55, or may be curved. Angled sides 51 assist in transmitting the pushing and pulling forces exerted along chain 39 such that chain 39 may more smoothly travel through corner joint 43, with minimal friction. According to some embodiments, chain 39 may be replaced by some other flexible, elongate member. The use of a chain may reduce friction compared to other flexible elongate members, and the chain may as a result experience less wear and tear.

While the present embodiment uses a locking mechanism with locking bars 48 and locking tubes 44, the disclosure extends to other types of locking devices. For example, a magnetic locking mechanism could be uses whereby magnets on the window frame jamb may be moved out of/into alignment with corresponding magnets on the vertical window sash.

According to some embodiments, it is possible for lead screw 10 to be implemented without locking mechanism 40.

While hinge 60 and suspension rod 200 have been described in the context of their use with lead screw 10 and locking mechanism 40, hinge 60 and suspension rod 200 may be used with any other window system in which the weight of the window (such as a side-hung window or a top-hung window) is to be supported by suspension rod 200 instead of hinge 60.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. A window system comprising:
a window movable relative to a window frame; and
a device for opening and closing the window, comprising:
a lead screw; and
at least one rigid arm connecting the window to the lead screw,
wherein operation of the device for opening and closing the window causes the at least one rigid arm to move between a first position in which the window is closed and a second position in which the window is open.

2. The window system of claim 1, wherein:
the device for opening and closing the window comprises an actuator;
the lead screw comprises:
at least one threaded shaft; and
at least one threaded nut engaged to the at least one threaded shaft; and
operation of the actuator causes the at least one threaded shaft to rotate and thereby causes corresponding translation of the at least one threaded nut between an extended position and a retracted position for respectively moving the at least one rigid arm between the first position and the second position.

3. The window system of claim 2, wherein the at least one threaded nut is connected to the at least one rigid arm.

4. The window system of claim 2, wherein the actuator comprises a handle for manually operating the device for opening and closing the window.

5. The window system of claim 4, wherein:
the at least one threaded nut comprises a first threaded nut connected to the at least one rigid arm, and a second threaded nut connected to the handle; and
translation of the handle causes corresponding translation of the second threaded nut and corresponding rotation of the at least one threaded shaft.

6. The window system of claim 4, wherein the handle is configured to be operated in response to a load of at least 5 pounds being applied to the handle.

7. The window system of claim 2, wherein the actuator comprises a motor operable to drive rotation of the at least one threaded shaft.

8. The window system of claim 2, wherein the at least one threaded shaft comprises thereon:
a thread of a first pitch; and
a thread of a second pitch steeper than the first pitch.

9. The window system of claim 8, wherein the at least one threaded nut comprises:
a first threaded nut connected to the at least one rigid arm and engaged to the thread of the second pitch; and
a second threaded nut connected to the actuator and engaged to the thread of the first pitch.

10. The window system of claim 1, further comprising:
a hinge connecting the window to a sill of the window frame; and
a load-bearing suspension device connecting the window frame to the window.

11. The window system of claim 10, wherein one or both of the hinge and the load-bearing suspension device comprises carbon fiber.

12. The window system of claim 10, wherein the load-bearing suspension device comprises:
a first end attached to the window frame;
a second end attached to the window; and
a flexible rod connecting the first and second ends and configured to rotate during opening or closing of the window relative to the window frame.

13. The window system of claim 10, wherein the hinge is a three-part hinge consisting of:
a bracket fixed to the sill;
a first member pivotable relative to the bracket;
a second member fixed to the window and pivotable relative to the first member; and
a third member pivotable relative to the second member and the bracket.

14. The window system of claim 1, wherein:
the window system further comprises a locking mechanism for locking the window when the window is closed; and
operation of the device for opening and closing the window further causes the locking mechanism to transition between a locked state in which the window is locked when the window is closed, and an unlocked state in which the window is unlocked.

15. The window system of claim 14, wherein:
operation of the device for opening and closing the window further causes the at least one rigid arm to move between the first position in which the window is closed and the locking mechanism is in the locked state, and the second position in which the window is open and the locking mechanism is in the unlocked state.

16. The window system of claim 14, wherein the locking mechanism comprises:
one or more first locking members on the window; and
one or more second locking members coupled to the window frame and movable, in response to operation of the device for opening and closing the window, between a locked position in which the locking mechanism is in the locked state, and an unlocked position in which the locking mechanism is in the unlocked state.

17. The window system of claim 16 wherein:
the one or more second locking members are movable relative to a vertical jamb of the window frame.

18. The window system of claim 16, wherein the one or more second locking members are translatable between the locked position and the unlocked position.

19. The window system of claim 16, wherein:
the one or more second locking members comprise one or more locking bars movably connected to the window frame and configured:
when in the locked position and when the window is closed, to prevent movement of the one or more first locking members; and
when in the unlocked position, to permit movement of the one or more first locking members.

20. The window system of claim 19, wherein the one or more locking bars are rotatably connected to the window frame.

21. The window system of claim 16, wherein:
the one or more second locking members are provided on a movable platform connected to a corner joint; and
the lead screw is connected to the corner joint.

22. The window system of claim 21, wherein:
the lead screw comprises at least one threaded shaft engaged to at least one threaded nut connected to the corner joint; and
the corner joint is configured to convert linear translation of the at least one threaded nut in a first direction into linear translation of the movable platform in a second direction.

23. The window system of claim 1, wherein the device for opening and closing the window is provided on a sill of the window frame.

24. The window system of claim 1, wherein the window is a side-hung window.

25. The window system of claim 1, wherein the at least one rigid arm is articulated.

26. The window system of claim 1, wherein the at least one rigid arm is connected to the window with a window operating control device for selectively controlling the extent to which the window may be opened relative to the window frame.

27. The window system of claim 26, wherein the window operating control device comprises:
a first portion rotatable relative to the at least one arm; and
a second portion fixed to the window and adjustable between a first configuration in which the second portion is fixed relative to the first portion, and a second configuration in which the second portion is rotatable relative to the first portion.

28. The window system of claim 1, wherein the locking mechanism is connected to the lead screw using an elongate flexible member passing through a corner joint, and wherein rotation of the lead screw about its longitudinal axis causes:
a first portion of the elongate flexible member to move through the corner joint in a direction perpendicular to the longitudinal axis; and
a second portion of the elongate flexible member to move through the corner joint in a direction parallel to the longitudinal axis.

29. The window system of claim 28, wherein the elongate flexible member comprises a chain.

30. A hinge mechanism for a window pivotable relative to a window frame, wherein the hinge mechanism comprises:
a hinge for connecting the window to a sill of the window frame; and
a load-bearing suspension device comprising:
a first end for attaching to the window frame;
a second end for attaching to the window; and
a flexible rod connecting the first and second ends and configured to rotate during opening or closing of the window relative to the window frame.

31. The hinge mechanism of claim 30, wherein one or both of the hinge and the load-bearing suspension device comprises carbon fiber.

32. The hinge mechanism of claim 30, wherein the hinge is a three-part hinge consisting of:
a bracket for fixing to the sill;
a first member pivotable relative to the bracket;
a second member for fixing to the window and pivotable relative to the first member; and
a third member pivotable relative to the second member and the bracket.

33. The hinge mechanism of claim 30, wherein the window is a side-hung or a top-hung window.

34. A corner joint for a window system, comprising:
a first conduit extending in a first direction;
a second conduit coupled to the first conduit and extending in a second direction perpendicular to the first direction; and
a chain passing through the first and second conduits,
wherein the first and second conduits define, where the first and second conduits meet, one or more portions for assisting a force extending along the chain in the first direction to be transmitted along the chain in the second direction.

35. The corner joint of claim 34, wherein the one or more portions comprise one or more angled portions.

36. The corner joint of claim 34, wherein the one or more portions comprise one or more curved portions.
